(19) United States
(12) Patent Application Publication
(10) Pub. No.: US 2022/0018803 A1
(43) Pub. Date: Jan. 20, 2022

(54) GAS SENSOR

(71) Applicant: DENSO CORPORATION, Kariya-city (JP)

(72) Inventors: Kei SUGIURA, Kariya-city (JP); Toru TAKEUCHI, Kariya-city (JP)

(21) Appl. No.: 17/485,904

(22) Filed: Sep. 27, 2021

Related U.S. Application Data
(63) Continuation of application No. PCT/JP2020/002488, filed on Jan. 24, 2020.

(30) Foreign Application Priority Data
Mar. 28, 2019 (JP) 2019-063492

(51) Int. Cl. G01N 27/407; G01N 27/406; G01N 27/409; B01D 53/02

(52) U.S. Cl. CPC G01N 27/4071; G01N 27/4067; G01N 27/409; B01D 2259/4566; B01D 2253/104; B01D 2257/93; B01D 53/02

(57) ABSTRACT

A gas sensor includes a sensor element that has an atmospheric-air introduction path into which atmospheric air is introduced. The sensor element includes a solid electrolyte body, an insulating body, an exhaust electrode, and an atmosphere electrode. The solid electrolyte body has ion conductivity. The insulating body is laminated onto the solid electrolyte body. The exhaust electrode is provided in the solid electrolyte body and exposed to an exhaust gas. The atmosphere electrode is provided in a position that opposes the exhaust electrode in the solid electrolyte body. The atmosphere electrode is used so as to be paired with the exhaust electrode, and is exposed to atmospheric air. The atmospheric-air introduction path is formed to house the atmosphere electrode in a section of the insulating body that opposes the solid electrolyte body. The atmospheric-air introduction path is provided with a trap layer for capturing toxic substances in the sensor element.

### CROSS-REFERENCE TO RELATED APPLICATION

The present application is a continuation application of International Application No. PCT/JP2020/002488, filed on Jan. 24, 2020, which claims priority to Japanese Patent Application No. 2019-063492, filed on Mar. 28, 2019. The contents of these applications are incorporated herein by reference in their entirety.

### BACKGROUND

### Technical Field

The present disclosure relates to a gas sensor that includes a sensor element that has an atmospheric-air introduction path.

### Related Art

A gas sensor is arranged in an exhaust pipe of an internal combustion engine or the like. With an exhaust gas that flows through the exhaust pipe as a gas to be detected, the gas sensor is used to determine an air-fuel ratio of the internal combustion engine, an oxygen concentration in the exhaust gas, and the like.

### SUMMARY

One aspect of the present disclosure provides a gas sensor that includes a sensor element that has an atmospheric-air introduction path into which atmospheric air is introduced. The atmospheric-air introduction path is provided with a trap layer for capturing toxic substances in the sensor element.

### BRIEF DESCRIPTION OF THE DRAWINGS

In the accompanying drawings:

FIG. 1 is a cross-sectional view of a gas sensor according to an embodiment;

FIG. 2 is a cross-sectional view of a sensor element according to the embodiment;

FIG. 3 is a cross-sectional view of the sensor element according to the embodiment, taken along in FIG. 2;

FIG. 4 is a cross-sectional view of the sensor element according to the embodiment, taken along IV-IV in FIG. 2;

FIG. 5 is a photograph of a cross-section of an atmosphere electrode and a trap layer in the sensor element according to the embodiment;

FIG. 6 is a cross-sectional view schematically showing an enlarged cross-section of the trap layer in the sensor element according to the embodiment;

FIG. 7 is a cross-sectional view of another sensor element in which the trap layer differs from that in FIG. 2, according to the embodiment;

FIG. 8 is a cross-sectional view of another sensor element in which the trap layer differs from that in FIG. 2, according to the embodiment; and

FIG. 9 is a cross-sectional view of another sensor element in which the trap layer differs from that in FIG. 2, according to the embodiment.

### DESCRIPTION OF THE EMBODIMENTS

A gas sensor is arranged in an exhaust pipe of an internal combustion engine or the like. With an exhaust gas that flows through the exhaust pipe as a gas to be detected, the gas sensor is used to determine an air-fuel ratio of the internal combustion engine, an oxygen concentration in the exhaust gas, and the like. In the gas sensor, a sensor element that includes a solid electrolyte body that has oxygen ion conductivity and a pair of electrodes that are provided on a surface of the solid electrolyte body is used. One electrode is used as an exhaust electrode that is exposed to the exhaust gas. The other electrode is used as an atmosphere electrode that serves as a counter electrode that conducts oxygen ions between the atmosphere electrode and the exhaust electrode. For example, a laminated-type gas sensor element described in JP-A-2002-286680 is known as such a sensor element.

The exhaust gas contains toxic substances that are deposited onto the exhaust electrode and poison (degrade) the exhaust electrode. Therefore, in the sensor element, a porous protective layer that is capable of capturing toxic substances is provided on a path through which the exhaust gas is introduced to the exhaust electrode. Meanwhile, the porous protective layer is not provided on a path through which atmospheric air is introduced to the atmosphere electrode. A reason for this is that, even should substances contained in the atmospheric air be deposited onto the atmosphere electrode, performance of the atmosphere electrode is thought to not be significantly affected.

However, in cases in which a large amount of atmospheric air is required in the atmosphere electrode or the like, higher performance is required of the atmosphere electrode. It has been found that, to maintain the required performance of the atmosphere electrode, the atmosphere electrode is required to be protected from poisoning (degradation). As such cases, for example, a case in which, when the gas sensor is used as an air-fuel ratio sensor that detects the air-fuel ratio of the internal combustion engine, the air-fuel ratio of the internal combustion engine is in an extremely fuel-rich state compared to a theoretical air-fuel ratio can be considered.

It is thus desired to provide a gas sensor that is capable of capturing toxic substances and supplying required oxygen to an atmospheric-air introduction path.

An exemplary embodiment of the present disclosure provides a gas sensor that includes a sensor element that has an atmospheric-air introduction path into which atmospheric air is introduced. The atmospheric-air introduction path is provided with a trap layer for capturing toxic substances in the sensor element.

In the gas sensor according to the above-described exemplary embodiment, the trap layer is provided on the atmospheric-air introduction path of the sensor element. As a result, even in cases in which a large amount of oxygen in the atmospheric air is required in the atmospheric-air introduction path of the sensor element, the toxic substances in the atmospheric air can be captured by the trap layer, and the large amount of oxygen can be supplied to the atmospheric-air introduction path.

Consequently, as a result of the gas sensor according to the above-described aspect, toxic substances can be captured and required oxygen can be supplied to the atmospheric-air introduction path.

Here, reference numbers in parentheses of the constituent elements according to an aspect of the present disclosure indicate corresponding relationships with reference numbers in the drawings according to the embodiments, but do not limit the constituent elements to only the contents according to the embodiments.

Preferred embodiments of the above-described gas sensor will be described with reference to the drawings.

### EMBODIMENTS

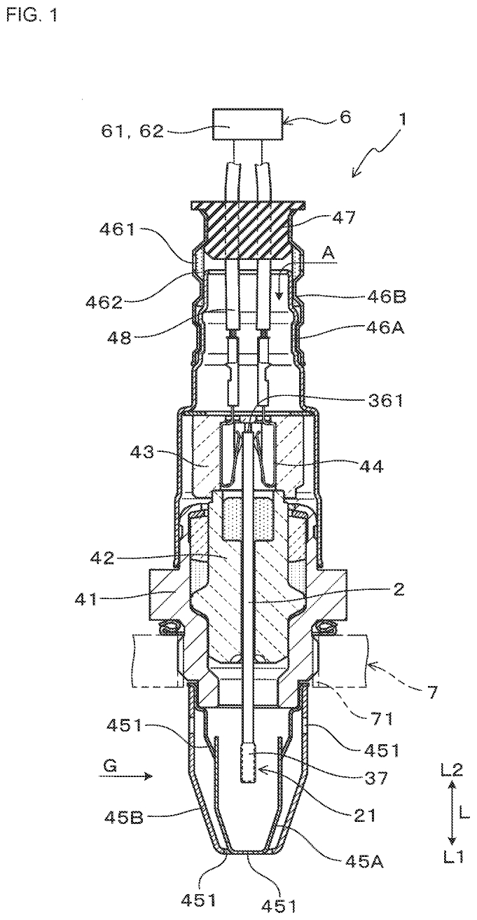

As shown in FIG. 1 to FIG. 4, a gas sensor 1 according to a present embodiment includes a sensor element 2 that has a gas chamber 35 and an atmospheric air duct 36. An exhaust gas G is introduced into the gas chamber 35. The atmospheric air duct 36 serves as an atmospheric-air introduction path into which atmospheric air A is introduced. A trap layer 5 for capturing toxic substances in the sensor element 2 is provided inside the atmospheric air duct 36.

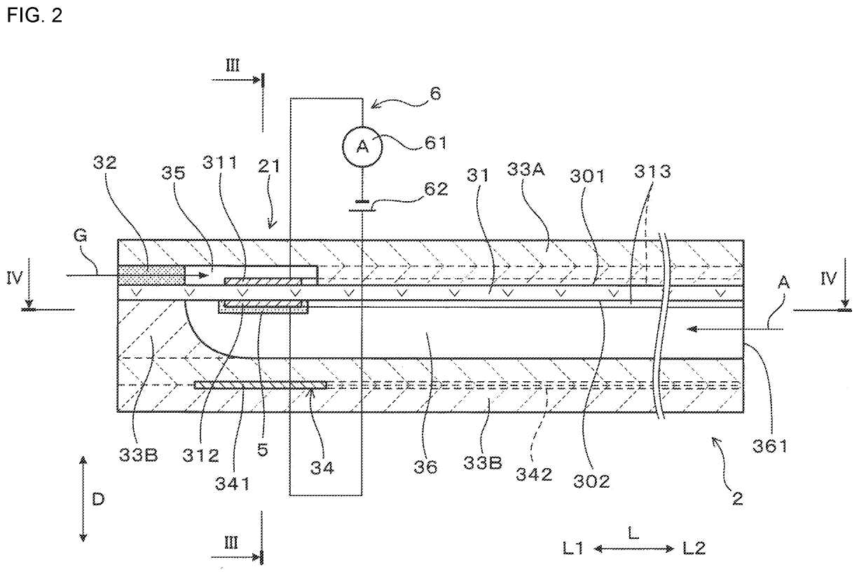

As shown in FIG. 2 to FIG. 4, the sensor element 2 includes a solid electrolyte body 31, a first insulating body 33A and a second insulating body 33B, an exhaust electrode 311, and an atmosphere electrode 312. The solid electrolyte body 31 has ion conductivity. The first insulating body 33A and the second insulating body 33B are laminated onto the solid electrolyte body 31. The exhaust electrode 311 is provided on a first surface 301 of the solid electrolyte body 31. The atmosphere electrode 312 is provided on a second surface 302 of the solid electrolyte body 31 in a position opposing the exhaust electrode 311 (a position overlapping the exhaust electrode 311 in a lamination direction D). The exhaust electrode 311 is housed inside the gas chamber 35 and exposed to the exhaust gas G The atmosphere electrode 312 is used so as to be paired with the exhaust electrode 311. The atmosphere electrode 312 is housed inside the atmospheric air duct 36 and is exposed to the atmospheric air A.

The gas chamber 35 is formed in a section of the first insulating body 33A that opposes the first surface 301 of the solid electrolyte body 31. The exhaust gas G is introduced into the gas chamber 35. The gas chamber 35 houses the exhaust electrode 311. The atmospheric air duct 36 is formed in a section of the second insulating body 33B that opposes the second surface 302 of the solid electrolyte body 31. The atmospheric air A is introduced into the atmospheric air duct 36. The atmospheric air duct 36 houses the atmosphere electrode 312.

The gas sensor 1 according to the present embodiment will be described in detail below.

### (Gas Sensor 1)

As shown in FIG. 1, the gas sensor 1 is arranged in an attachment opening 71 of an exhaust pipe 7 of an internal combustion engine (engine) of a vehicle. The gas sensor 1 is used to detect an oxygen concentration and the like in a gas to be detected, the gas to be detected being the exhaust gas G that flows through the exhaust pipe 7. The gas sensor 1 can be used as an air-fuel ratio sensor (A/F sensor) that determines an air-fuel ratio in the internal combustion engine, based on the oxygen concentration, an unburned gas concentration, or the like in the exhaust gas G Moreover, the gas sensor 1 can be used in various applications in which the oxygen concentration is determined, in addition to the air-fuel ratio sensor.

A catalyst for purifying toxic substances in the exhaust gas G is arranged in the exhaust pipe 7. The gas sensor 1 may be arranged on either of an upstream side and a downstream side of the catalyst in a direction of flow of the exhaust gas G in the exhaust pipe 7. In addition, the gas sensor 1 can also be arranged in a pipe on an intake side of a supercharger that increases density of air that is taken into the internal combustion engine using the exhaust gas G Furthermore, the pipe in which the gas sensor 1 is arranged can also be a pipe in an exhaust-gas recirculation mechanism that recirculates a portion of the exhaust gas G that is discharged from the internal combustion engine into the exhaust pipe 7 to an intake pipe of the internal combustion engine.

The air-fuel ratio sensor can quantitatively and continuously detect the air-fuel ratio from a fuel-rich state to a fuel-lean state. In the fuel-rich state, a proportion of fuel in relation to air is greater than that of the theoretical air-fuel ratio. In the fuel-lean state, the proportion of fuel in relation to air is less than that of the theoretical air-fuel ratio. In the air-fuel ratio sensor, when a diffusion speed of the exhaust gas G that is led into the gas chamber 35 is reduced as a result of a diffusion resistance portion (diffusion control portion) 32, a predetermined voltage for indicating a limiting current characteristic at which a current that is based on an amount of movement of oxygen ions (O²⁻) is outputted is applied between the exhaust electrode 311 and the atmosphere electrode 312.

In the air-fuel ratio sensor, when the air-fuel ratio that is on the fuel-lean side is detected, a current that is generated when oxygen contained in the exhaust gas G becomes ions and moves from the exhaust electrode 311 to the atmosphere electrode 312 through the solid electrolyte body 31 is detected. In addition, in the air-fuel ratio sensor, when the air-fuel ratio that is on the fuel-rich side is detected, oxygen that has become ions moves from the atmosphere electrode 312 to the exhaust electrode 311 through the solid electrolyte body 31 to be reacted with unburned gas (hydrocarbon, carbon monoxide, hydrogen, and the like) that is contained in the exhaust gas G A current that is generated when the unburned gas and the oxygen react is detected.

For example, when the air-fuel ratio that is detected by the air-fuel ratio sensor is an air-fuel ratio that is further toward the fuel-rich side, such as A/F=10 (air mass/fuel mass is 10) or less, a sufficient amount of oxygen is required to be moved from the atmosphere electrode 312 to the exhaust electrode 311 through the solid electrolyte body 31 to burn a large amount of unburned gas. In this case, when the atmosphere electrode 312 is in a degraded state as a result of toxic substances being deposited onto the atmosphere electrode 312, a number of reactive sites in the atmosphere electrode 312 at which oxygen molecules are decomposed and become ions decreases. Sending sufficient oxygen ions from the atmosphere electrode 312 to the exhaust electrode 311 through the solid electrolyte body 31 becomes difficult. As a result, detection performance regarding the air-fuel ratio on the fuel-rich side decreases as a result of decrease in activity of the atmosphere electrode 312.

In the sensor element 2 according to the present embodiment, as a result of the trap layer 5 being provided inside the atmospheric air duct 36, the trap layer 5 can capture toxic substances in the atmospheric air A that is introduced into the atmospheric air duct 36. As a result, decrease in the number of reactive sites in the atmosphere electrode 312 can be suppressed. Sufficient oxygen ions can be sent from the atmosphere electrode 312 to the exhaust electrode 311 through the solid electrolyte body 31.

### (Other Gas Sensors 1)

The gas sensor 1 may be a sensor that detects a concentration of a specific gas component, such as NOx (nitrogen oxide). In an NOx sensor, a pump electrode is arranged on an upstream side of the flow of exhaust gas G that comes into contact with the exhaust electrode 311. The pump electrode pumps oxygen from the exhaust electrode 311 to the atmosphere electrode 312 by application of a voltage. The atmosphere electrode 312 is also formed in a position that opposes the pump electrode with the solid electrolyte body 31 therebetween. When the gas sensor 1 is used as the NOx sensor, as a result of the trap layer 5 being arranged inside the atmospheric air duct 36, poisoning of the atmosphere electrode 312 can be suppressed and decrease in detection performance regarding the NOx concentration can be suppressed.

### (Toxic Substances)

Among the toxic substances in the atmospheric air A that may poison the atmosphere electrode 312, there are organic polymer gases such as siloxane gas that are generated in an engine compartment and the like of the vehicle. Pipes other than atmospheric gas pipes such as the exhaust pipe 7 in which the gas sensor 1 is arranged often contain the atmospheric air A that flows from the engine compartment. The toxic substances of the atmosphere electrode 312 refer to substances that are deposited onto the atmosphere electrode 312 and have properties that degrade the performance of the atmosphere electrode 312. In addition, the exhaust gas G may contain substances that may poison the exhaust electrode 311. In this case, for example, as shown in FIG. 1, the toxic substances contained in the exhaust gas G can be captured by a porous layer 37 that is provided on the surface of the sensor element 2.

### (Sensor Element 2)

As shown in FIG. 2 to FIG. 4, the sensor element 2 according to the present embodiment is formed into an elongated rectangular shape and includes the solid electrolyte body 31, the exhaust electrode 311, the atmosphere electrode 312, the first insulating body 33A, the second insulating body 33B, the gas chamber 35, the atmospheric air duct 35, and a heat generating body 34. The sensor element 2 is a laminated type in which the insulating bodies 33A and 33B and the heat generating body 34 are laminated onto the solid electrolyte body 31.

According to the present embodiment, a longitudinal direction L of the sensor element 2 refers to a direction in which the sensor element 2 extends in an elongated shape. In addition, a direction that is orthogonal to the longitudinal direction L and in which the solid electrolyte body 31 and the insulating bodies 33A an 33B are laminated, or in other words, a direction in which the solid electrolyte body 31, the insulating bodies 33A and 33B, and the heat generating body 34 are laminated is referred to as a lamination direction F. Furthermore, a direction that is orthogonal to the longitudinal direction L and the lamination direction F is referred to as a width direction W. Moreover, in the longitudinal direction L of the sensor element 2, a side that is exposed to the exhaust gas G is referred to as a tip end side L1 and a side opposite the tip end side L1 is referred to as a rear end side L2.

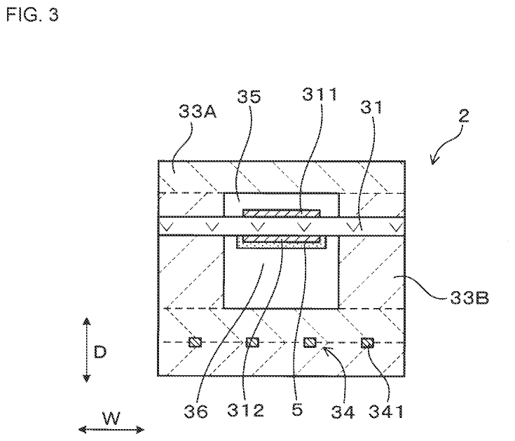

(Solid electrolyte body 31, exhaust electrode 311, and atmosphere electrode 312) As shown in FIG. 2 and FIG. 3, the solid electrolyte body 31 has conductivity regarding oxygen ions (O2−) at a predetermined activation temperature. The exhaust electrode 311 is provided on the first surface 301 of the solid electrolyte body 31 that comes into contact with the exhaust gas G The atmosphere electrode 312 is provided on the second surface 302 of the solid electrolyte body 31 that comes into contact with the atmospheric air A.

The exhaust electrode 311 and the atmosphere electrode 312 oppose each other with the solid electrolyte body 31 therebetween, in a section on the tip end side L1 that is exposed to the exhaust gas G in the longitudinal direction L of the sensor element 2. In the section on the tip end side L1 in the longitudinal direction L of the sensor element 2, a detecting portion 21 that is configured by the exhaust electrode 311, the atmosphere electrode 312, and a section of the solid electrolyte body 31 that is sandwiched between the electrodes 311 and 312 is formed. The first insulating body 33A is laminated on the first surface 301 of the solid electrolyte body 31. The second insulating body 33B is laminated on the second surface 302 of the solid electrolyte body 31.

The solid electrolyte body 31 is made of zirconia oxide. With zirconia as a main component (with a content of 50 mass % or greater), the solid electrolyte body 31 is made of stabilized zirconia or partially stabilized zirconia in which a portion of zirconia is substituted by a rare earth metal element or an alkaline earth metal element. A portion of the zirconia that configures the solid electrolyte body 31 can be substituted by yttria, scandia, or calcia.

The exhaust electrode 311 and the atmosphere electrode 312 contain platinum that serves as a noble metal that shows catalytic activity against oxygen, and zirconia oxide that serves as a co-material with the solid electrolyte body 31. The co-material is provided to maintain bonding strength between the exhaust electrode 311 and the atmosphere electrode 312 that are made of an electrode material, and the solid electrolyte body 31, when a paste-like electrode material is printed on (applied to) the solid electrolyte body 31 and both are fired.

As shown in FIG. 2, an electrode lead portion 313 for electrically connecting the exhaust electrode 311 and the atmosphere electrode 312 to outside the gas sensor 1 is connected to these electrodes 311 and 312. The electrode lead portion 313 is drawn out to a section on the rear end side L2 in the longitudinal direction L of the sensor element 2.

### (Gas Chamber 35)

As shown in FIG. 2 and FIG. 3, on the first surface 301 of the solid electrolyte body 31, the gas chamber 35 that is surrounded by the first insulating body 33A and the solid electrolyte body 31 is formed so as to be adjacent thereto. The gas chamber 35 is formed in a section on the tip end side L1 in the longitudinal direction L of the first insulating body 33A, in a position in which the exhaust electrode 311 is housed. The gas chamber 35 is formed as a space portion that is closed by the first insulating body 33A, the diffusion resistance portion 32, and the solid electrolyte body 31. The exhaust gas G that flows through the exhaust pipe 7 passes through the diffusion resistance portion 32 and is introduced into the gas chamber 35.

### (Diffusion Resistance Portion 32)

The diffusion resistance portion 32 according to the present embodiment is provided so as to be adjacent to the tip end side L1 in the longitudinal direction L of the gas chamber 35. The diffusion resistance portion 32 is arranged in the first insulating body 33A, inside an inlet that is open so as to be adjacent to the tip end side L1 in the longitudinal direction L of the gas chamber 35. The diffusion resistance portion 32 is formed to include a porous metal oxide such as alumina. A diffusion speed (flow rate) of the exhaust gas G that is introduced into the gas chamber 35 is determined by a speed at which the exhaust gas G passes through pores in the diffusion resistance portion 32 being restricted.

The diffusion resistance portion 32 may be formed so as to be adjacent on both sides in the width direction W of the gas chamber 35. In this case, the diffusion resistance portions 32 are arranged in the first insulating body 33A, inside inlets that are open so as to be adjacent to both sides in the width direction W of the gas chamber 35. Here, in addition to the diffusion resistance portion 32 being formed using a porous body, the diffusion resistance portion 32 can also be formed using a pin hole that is a small through-hole connected to the gas chamber 35.

### (Atmospheric Air Duct 36)

As shown in FIG. 2 to FIG. 4, on the second surface 302 of the solid electrolyte body 31, the atmospheric air duct 36 that is surrounded by the second insulating body 33B and the solid electrolyte body 31 is formed so as to be adjacent thereto. The atmospheric air duct 36 is formed in the second insulating body 33B, from a section in the longitudinal direction L in which the atmosphere electrode 312 is housed to a rear end position in the longitudinal direction L of the sensor element 2 that is exposed to the atmospheric air A. A rear-end opening portion that serves as an atmospheric-air introducing portion 361 of the atmospheric air duct 36 is formed in the rear end position in the longitudinal direction L of the sensor element 2. The atmospheric air duct 36 is formed from the rear-end opening portion to a position that overlaps the gas chamber 35 in the lamination direction D, with the solid electrolyte body 31 therebetween. The atmospheric air A is introduced into the atmospheric air duct 36 from the rear-end opening portion.

A cross-sectional area of a cross-section of the atmospheric air duct 36 that is orthogonal to the longitudinal direction L is greater than a cross-sectional area of a cross-section of the gas chamber 35 that is orthogonal to the longitudinal direction L. In addition, a thickness (width) in the lamination direction D of the atmospheric air duct 36 is greater than a thickness (width) in the lamination direction D of the gas chamber 35. As a result of the cross-sectional area, thickness, volume, and the like of the atmospheric air duct 36 being greater than the cross-sectional area, thickness, volume, and the like of the gas chamber 35, oxygen in the atmospheric air A for reacting with the unburned gas in the exhaust electrode 311 can be sufficiently supplied from the atmospheric air duct 36 to the exhaust electrode 311.

### (Heat Generating Body 34)

As shown in FIG. 2 to FIG. 4, the heat generating body 34 is provided so as to be embedded in the second insulating body 33B that forms the atmospheric air duct 36, and includes a heat generating portion 341 that generates heat by energization and a heat generating body lead portion 342 that is connected to the heat generating portion 341. The heat generating portion 341 is arranged in a position in which at least a portion overlaps the exhaust electrode 311 and the atmosphere electrode 312, in the lamination direction D of the solid electrolyte body 31 and the insulating bodies 33A and 33B.

In addition, the heat generating body 34 includes the heat generating portion 341 that generates heat by energization and the pair of heat generating body lead portions 342 that is connected to the rear end side L2 in the longitudinal direction L of the heat generating portion 341. The heat generating portion 341 is formed by a linear conductor portion that meanders by a straight portion and a curved portion. The straight portion of the heat generating portion 341 according to the present embodiment is formed parallel to the longitudinal direction L. The heat generating body lead portion 342 is formed by the straight conductor portion. A resistance value per unit length of the heat generating portion 341 is greater than a resistance value per unit length of the heat generating body lead portion 342. The heat generating body lead portion 342 is drawn out to a section on the rear end side L2 in the longitudinal direction L. The heat generating body 34 contains a metal material that has conductivity.

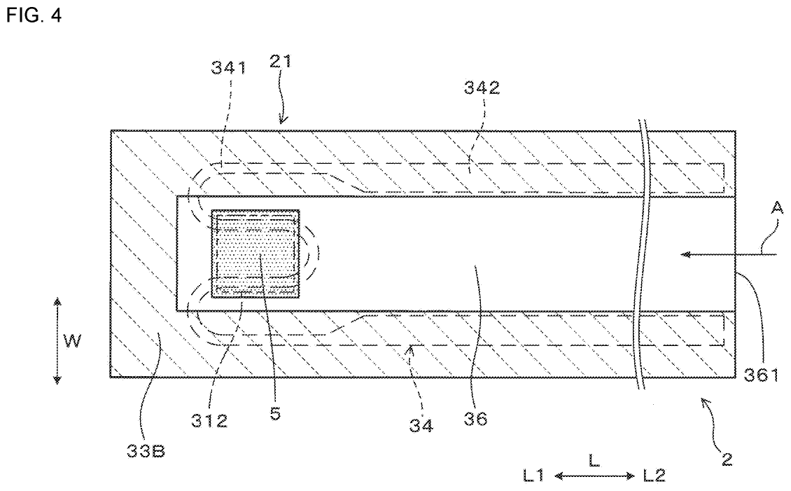

As shown in FIG. 4, the heat generating portion 341 according to the present embodiment is formed into a shape that meanders in the longitudinal direction L in a position on the tip end side L1 in the longitudinal direction L of the heat generating body 34. Here, the heat generating portion 341 may be formed so as to meander in the width direction W. The heat generating portion 341 is arranged in a position that opposes the exhaust electrode 311 and the atmosphere electrode 312 in the lamination direction D orthogonal to the longitudinal direction L. In other words, the heat generating portion 341 is arranged in a position that overlaps the exhaust electrode 311 and the atmosphere electrode 312 in the lamination direction D, in a section on the tip end side L1 in the longitudinal direction L of the sensor element 2.

A cross-sectional area of the heat generating portion 341 is smaller than a cross-sectional area of the heat generating body lead portion 342. The resistance value per unit length of the heat generating portion 341 is higher than the resistance value per unit length of the heat generating body lead portion 342. This cross-sectional area refers to a cross-sectional area of a plane that is orthogonal to a direction in which the heat generating portion 341 and the heat generating body lead portion 342 extend. In addition, when a voltage is applied to the pair of heat generating body lead portions 342, the heat generating portion 341 generates heat by Joule heat. As a result of this heat generation, a vicinity of the detecting portion 21 is heated.

As a result of the heat generating body 341 generating heat by energization from the heat generating body lead portion 342, the exhaust electrode 311, the atmosphere electrode 312, and the section of the solid electrolyte body 31 that is sandwiched between the electrodes 311 and 312 are heated to a target temperature. At this time, in the longitudinal direction L of the solid electrolyte body 31, a temperature distribution that is based on heating by the heating portion 341 and in which the temperature becomes higher in sections closer to the heat generating portion 341 is formed. The trap layer 5 is set in a position in which the temperature in the temperature distribution is 500° C. or higher. In other words, during use of the gas sensor 1, the atmosphere electrode 312 in which the trap layer 5 is provided is heated to 500° C. or higher, and the trap layer 5 is also heated to 500° C. or higher.

A section of the atmospheric air duct 36 that opposes the heat generating portion 341 is heated to 500° C. or higher. In addition, an area from a tip end in the longitudinal direction L of the sensor element 2 to 15 mm toward a base end side L2 can be considered to be a section that is heated to 500° C. or higher. A heat generation amount of the heat generating portion 341 can be set such that a heat generation center of the heat generating portion 341 is 550° C. to 650° C. In addition, an area that is 20% on the tip end side L1 of an overall length in the longitudinal direction L of the sensor element 2 can be considered to be a section that is heated to 500° C. or higher.

As a result of the trap layer 5 being provided in the section of the sensor element 2 in which the temperature is 500° C. or higher, toxic substances that are diffused in the vicinity of the trap layer 5 can be reduced in molecular weight. As a result, the toxic substances can be more easily adhered (attached) to the trap layer 5, and the toxic substances can be less easily detached from the trap layer 5.

### (Insulating Bodies 33A and 33B)

As shown in FIG. 2 and FIG. 3, the first insulating body 33A forms the gas chamber 35. The second insulating body 33B forms the atmospheric air duct 36 and embeds the heat generating body 34 therein. The first insulating body 33A and the second insulating body 33B are formed by a metal oxide such as alumina (aluminum oxide). The insulating bodies 33A and 33B are formed as dense bodies through which the exhaust gas G and the atmospheric air A cannot pass. Pores through which a gas is able to pass are hardly formed in the insulating bodies 33A and 33B.

### (Porous Layer 37)

As shown in FIG. 1, the porous layer 37 for capturing substances that are toxic to the exhaust electrode 311, condensate that is produced inside the exhaust pipe 7, and the like is provided over an overall periphery of the section on the tip end side L1 in the longitudinal direction L of the sensor element 2. The porous layer 37 is formed to include a porous ceramic (metal oxide) such as alumina. A porosity of the porous layer 37 is greater than a porosity of the diffusion resistance portion 32. A flow rate of the exhaust gas G that can pass through the porous layer 37 is greater than a flow rate of the exhaust gas G that can pass through the diffusion resistance portion 32.

### (Other Configurations of the Gas Sensor 1)

As shown in FIG. 1, the gas sensor 1 includes, in addition to the sensor element 2, a first insulator 42 that holds the sensor element 2, a housing 41 that holds the first insulator 42, a second insulator 43 that is connected to the first insulator 42, and a contact terminal 44 that is held by the second insulator 43 and in contact with the sensor element 2. In addition, the gas sensor 1 includes element covers 45A and 45B that are mounted in a section on the tip end side L1 of the housing 41 and cover a section on the tip end side of the sensor element 2, a second insulator 43 that is mounted in a section on the rear end side L2 of the housing 41, atmosphere covers 46A and 46B that cover the contact terminal 44 and the like, a bush 47 for holding a lead wire 48 that is connected to the contact terminal 44 to the atmosphere covers 46A and 46B, and the like.

The section on the tip end side of the sensor element 2, and element covers 45A and 45B are arranged inside the exhaust pipe 7 of the internal combustion engine. A gas passage hole 451 for allowing the exhaust gas G that serves as the gas to be detected to pass is formed in the element covers 45A and 45B. The element covers 45A and 45B have a double-layer structure made of an inner cover 45A and an outer cover 45B that covers the inner cover 45A. The element covers 45A and 45B may also have a single-layer structure. The exhaust gas G that flows from the gas passage hole 451 in the element covers 45A and 45B into the element covers 45A and 45B passes through the porous layer 37 and the diffusion resistance portion 32 of the sensor element 2, and is led to the exhaust electrode 311.

As shown in FIG. 1, the atmosphere covers 46A and 46B are arranged outside the exhaust pipe 7 of the internal combustion engine. The gas sensor 1 according to the present embodiment is for in-vehicle use. A vehicle body in which the exhaust pipe 7 is arranged is connected to the engine compartment in which the internal combustion engine (engine) is arranged. In addition, gas that is produced from various rubbers, resins, lubricants, and the like in the engine compartment mixes with the atmospheric air A and flows around the atmosphere cover 46A and 46B. The gas that is produced inside the engine compartment forms toxic substances that may poison the atmosphere electrode 312. For example, the toxic substances that are produced in the engine compartment and the like may be silicon (Si) and sulfur (S).

The atmosphere covers 46A and 46B according to the present embodiment are configured by a first cover 46A that is attached to the housing 41 and a second cover 46B that covers the first cover 46A. An atmospheric-air passage hole 461 for allowing passage of the atmospheric air A is formed in the first cover 46A and the second cover 46B. A water repellent filter 462 for preventing infiltration of water into the first cover 46A is sandwiched between the first cover 46A and the second cover 46B in a position opposing the atmospheric-air passage hole 461.

The rear-end opening portion that serves as the atmospheric-air introducing portion 361 of the atmospheric air duct 36 in the sensor element 2 is open to a space inside the atmosphere covers 46A and 46B. The atmospheric air A that is present in the periphery of the atmospheric-air passage hole 461 of the atmosphere covers 46A and 46B is taken into the atmosphere covers 46A and 46B through the water repellant filter 462. In addition, the atmospheric air A that has passed through the water repellant filter 462 flows into the atmospheric air duct 36 from the rear-end opening portion that serves as the atmospheric-air introducing portion 361 of the atmospheric air duct 36 of the sensor element 2, and is led to the atmosphere electrode 312 inside the atmospheric air duct 36.

A plurality of contact terminals 44 are arranged in the second insulator 43 so as to be respectively connected to the electrode lead portions 313 of the exhaust electrode 311 and the atmosphere electrode 312, and the heat generating body lead portion 342 of the heat generating body 34. In addition, the lead wire 48 is connected to each of the contact terminals 44.

As shown in FIG. 1 and FIG. 2, the lead wire 48 in the gas sensor 1 is electrically connected to a sensor control apparatus 6 that performs control of gas detection in the gas sensor 1. The sensor control apparatus 6 performs electrical control in the gas sensor 1 in cooperation with an engine control apparatus that controls combustion driving in the engine. A current measuring circuit 61, a voltage applying circuit 62, an energizing circuit, and the like are formed in the sensor control apparatus 6. The current measuring circuit 61 measures a current that flows between the exhaust electrode 311 and the atmosphere electrode 312. The voltage applying circuit 62 applies a voltage between the exhaust electrode 311 and the atmosphere electrode 312. The energizing circuit performs energization of the heat generating body 34. Here, the sensor control apparatus 6 may be constructed inside the engine control apparatus.

### (Trap Layer 5)

As shown in FIG. 2 to FIG. 4, the trap layer 5 is formed to include a porous body of a metal oxide that has insulating properties. Specifically, the trap layer 5 according to the present embodiment is formed to include a porous body of α-alumina (Al₂O₃, trigonal aluminum oxide). The trap layer 5 is formed by particles of α-alumina that serves as the metal oxide being bonded to one another by firing. For example, as the particles of the metal oxide composing the trap layer 5, particles of α-alumina in which 90 mass % or more of the total have a grain size of 0.5 μm to 10 μm may be used.

As an alumina raw material of which particulates have a large material specific surface area, alumina hydrate that is obtained by a hydrolysis reaction of aluminum alkoxide is typically used. The alumina hydrate becomes α-alumina that is stable at high temperatures after becoming γ-alumina, θ-alumina, and the like that are intermediate products, as a result of heating at a high temperature. However, because grain growth occurs during α-transition, the α-alumina has a small specific surface area.

The θ-alumina is used in the porous layer 37 that captures the toxic substances in the exhaust gas G because the specific surface area is relatively large and crystalline modification does not occur at temperatures that are about that of the exhaust gas G. Meanwhile, the α-alumina of which a crystal structure is stable even at a firing temperature of the sensor element 2 is used in the trap layer 5 that captures the toxic substances in the atmospheric air

A.

As a result of the α-alumina being used in the trap layer 5, when the trap layer 5 is fired together with the sensor element 2, the crystal structure of the trap layer 5 can be stably maintained. Meanwhile, when the γ-alumina or the θ-alumina is used in the trap layer 5, when the trap layer 5 is fired, cracks, peeling, and the like may occur in the particles of the metal oxide composing the trap layer 5, bonding interfaces between the particles of the metal oxide, and the like.

The porous layer 37 is provided by an immersion method or an injection method on the surface of the sensor element 2 after the sensor element 2 is fired. The porous layer 37 is not fired together with the sensor element 2 and is merely required to have a crystal structure that is capable of withstanding the temperature of the exhaust gas G Meanwhile, the trap layer 5 is laminated together with the solid electrolyte body 31, the insulating bodies 33A and 33B, the exhaust electrode 311, the atmosphere electrode 312, and the like inside the sensor element 2, and is fired together with the sensor element 2 after becoming an intermediate body of the sensor element 2 before firing. Therefore, the α-alumina that can withstand even the firing temperature of the sensor element 2 is preferably used in the trap layer 5.

### (Micro Pores K1)

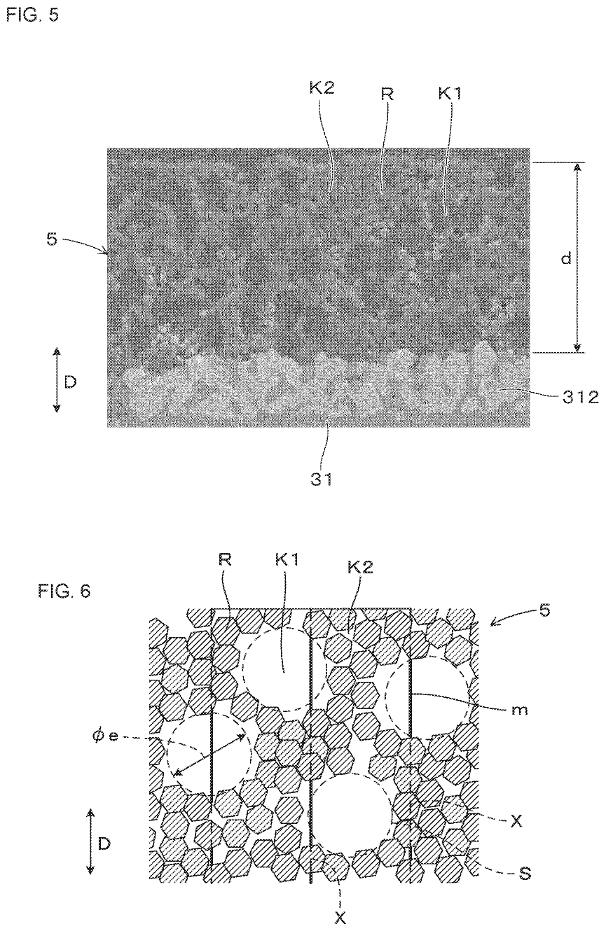

FIG. 5 shows a cross-section of the trap layer 5 that is formed on the surface of the atmosphere electrode 312 in the solid electrolyte body 31. In addition, FIG. 6 shows an enlarged cross-section of the trap layer 5. As shown in the drawings, gaps through which a gas is able to pass are formed in the trap layer 5. More specifically, macropores K1 and inter-particle gaps K2 are formed in the trap layer 5. The macropore K1 is formed as a result of unevenness in a distribution of particles R of the metal oxide. The inter-particle gap K2 is smaller than the macropore K1 and formed between the particles R of the metal oxide.

The macropore K1 can be formed using a burnout agent S, such as a resin that is burned out when the sensor element 2 is fired. The burnout agent is also referred to as a pore-forming agent. More specifically, in formation of the trap layer 5, a paste material that contains the particles R of the metal oxide, the burnout agent S, and a solvent (such as water) is used. The sensor element 2 that is coated with this paste material is fired. At this time, in the paste material, the burnout agent S is burned out, and the macropores K1 are formed as cavities in the portions in which the burnout agent S had been placed.

The macropores K1 and the inter-particle gaps K2 may be formed so as to communicate with each other. As a result of being formed using a spherical burnout agent S, the macropore K1 according to the present embodiment is formed so as to be close to spherical. Among the macropores K1, some macropores K1 that are adjacent to each other are connected together. In addition, the macropore K1 may be formed into shapes such as a circular column and a needle shape. Furthermore, gaps in the trap layer 5 may be formed by only the macropores K1 or the inter-particle gaps K2. Moreover, the macropores K1 can also be formed by a method in which the burnout agent S is not used.

The toxic substances contained in the atmospheric air A are trapped (captured) in the macropores K or the inter-particle gaps K2 when passing through the macropores K1 and the inter-particle gaps K2 that are formed in the trap layer 5, and cannot pass through the overall trap layer 5. In addition, oxygen and the like in the atmospheric air A pass through the macropores K1 and the inter-particle gaps K2 that are formed in the trap layer 5, and reaches the atmosphere electrode 312.

### (Formation Position of Trap Layer 5)

As shown in FIG. 2 to FIG. 4, the trap layer 5 is provided so as to cover the surface of the atmosphere electrode 312 that is provided on the second surface 302 of the solid electrolyte body 31. The trap layer 5 is for suppressing toxic substances being deposited onto the atmosphere electrode 312 and poisoning (degrading) the atmosphere electrode 312. The trap layer 5 is provided so as to cover the atmosphere electrode 312 and to be in contact with the second surface 302 of the solid electrolyte body 31. The trap layer 5 is provided in a state in which a flow path of the atmospheric air duct 36 is not filled, or in other words, the atmospheric air duct 36 is not sealed. Still in other words, the trap layer 5 is provided so as to be separated from the second insulating body 33B that forms the atmospheric air duct 36.

In addition, the atmospheric air duct 36 is continuously formed even in the section in which the trap layer 5 is provided. The overall surface of the trap layer 5 is exposed to the atmospheric are A inside the atmospheric air duct 36. As a result of the flow path of the atmospheric air duct 36 not being filled by the trap layer 5, a state in which the atmospheric air A can easily reach the atmosphere electrode 312 through the trap layer 5 is formed.

The trap layer 5 can be formed so as to cover the overall atmosphere electrode 312. In addition, the trap layer 5 can be formed so as to cover a portion of the atmosphere electrode 312. In this case, for example, the trap layer 5 may be formed so as to cover a center portion of the surface of the atmosphere electrode 312. In addition, the trap layer 5 can be formed to cover half of the surface of the atmosphere electrode 312 or more.

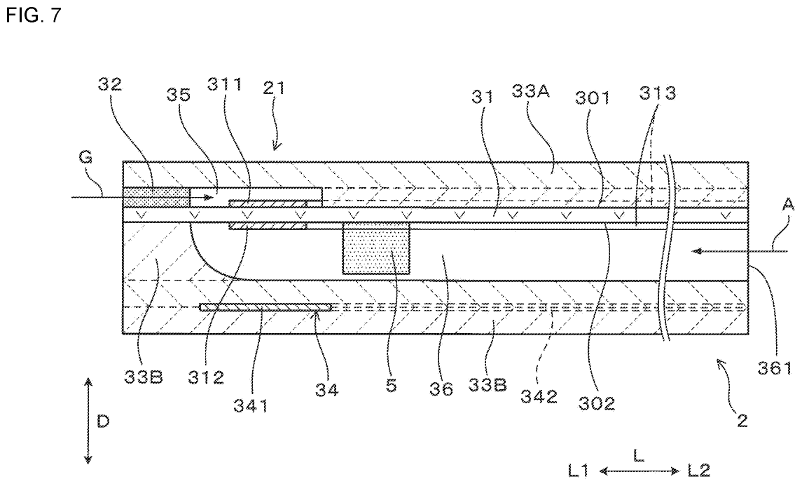

As shown in FIG. 7, the trap layer 5 can also be provided inside the atmospheric air duct 36 in a position that is further toward the rear end side L2 in the longitudinal direction L than the position in which the atmosphere electrode 312 is provided. In this case, the trap layer 5 can be provided inside the atmospheric air duct 36 in a state in which the flow path of the atmospheric air duct 36 is not filled, on the surface of at least either of the solid electrolyte body 31, and the second insulating body 33B that form the atmospheric air duct 36. The state in which the flow path of the atmospheric air duct 36 is not filled refers to a state in which the trap layer 5 that is arranged in a portion of the atmospheric air duct 36 in the longitudinal direction L is arranged in a portion of a cross-section of the atmospheric air duct 36 that is orthogonal to the longitudinal direction L.

In FIG. 7, the trap layer 5 is provided on the second surface 302 of the solid electrolyte body 31 in the position further toward the rear end side L2 in the longitudinal direction L than the atmosphere electrode 312. In this case, when the atmospheric air A that flows through the atmospheric air duct 36 from the rear end side L2 to the tip end side L1 passes the periphery of the trap layer 5, the toxic substances in the atmospheric air A are captured in the trap layer 5.

In addition, the trap layer 5 can be provided in a plurality of locations inside the atmospheric air duct 36. In this case, the trap layers 5 can be provided in positions that differ from each other in the longitudinal direction L on the second surface 302 of the solid electrolyte body 31 and an inner surface of the second insulating body 33B. In this case, the atmospheric air A inside the atmospheric air duct 36 can flow from the rear end side L2 to the tip end side L1 while meandering through the periphery of the trap layers 5. In addition, the toxic substances in the atmospheric air A that pass through the periphery of the trap layers 5 can be captured by the trap layers 5.

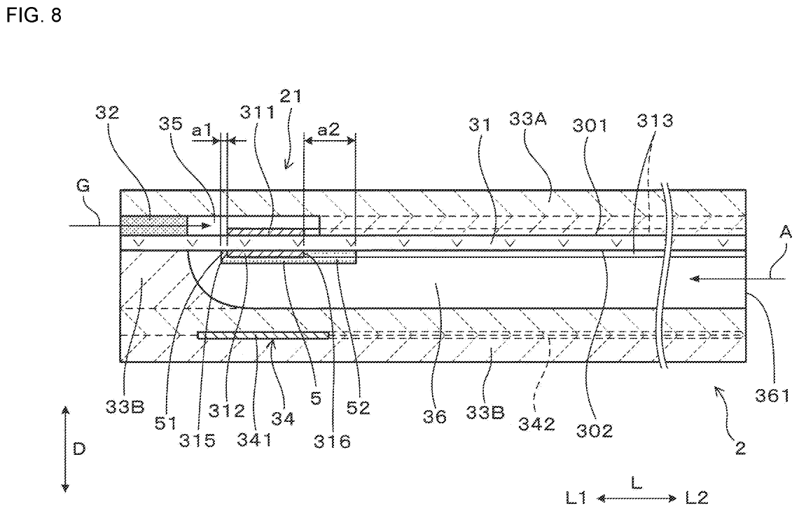

Furthermore, as shown in FIG. 8, the trap layer 5 may be provided so as to extend toward the rear end side L2 in the longitudinal direction L from the position covering the atmosphere electrode 312 on the second surface 302 of the solid electrolyte body 31. In other words, a length a2 in the longitudinal direction L of a rear-end-side portion 52 of the trap layer 5 that is formed so as to protrude toward the rear end side L2 in the longitudinal direction L from a rear end 316 of the atmosphere electrode 312 can be longer than a length a1 in the longitudinal direction L of a tip-end-side portion 51 of the trap layer 5 that is formed so as to protrude toward the tip end side L1 in the longitudinal direction L from a tip end 315 of the atmosphere electrode 312. In this case, the toxic substances in the atmospheric air A that pass through the atmospheric air duct 36 can be easily captured by the trap layer 5.

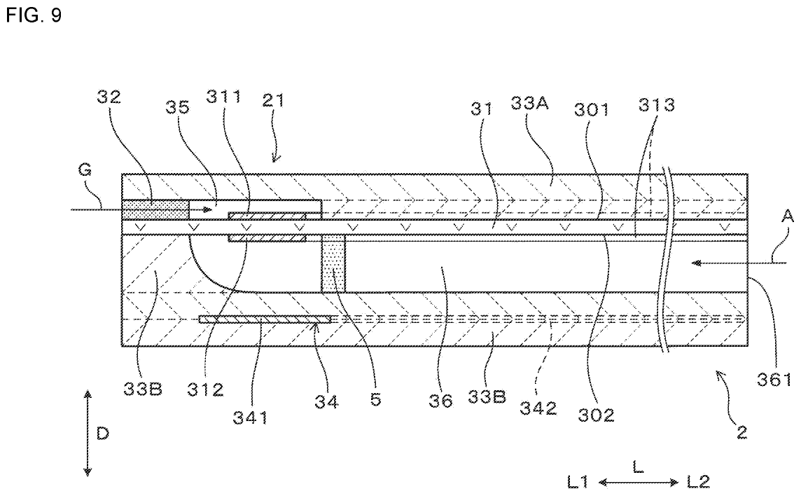

Here, as shown in FIG. 9, the trap layer 5 can be provided so as to seal a portion of the flow path in the longitudinal direction L of the atmospheric air duct 36. The state in which a portion of the flow path of the atmospheric air duct 36 is sealed refers to a state in which the trap layer 5 that is arranged in a portion of the atmospheric air duct 36 in the longitudinal direction L is arranged on an overall cross-section of the air duct 36 orthogonal to the longitudinal direction L. In this case, the trap layer 5 can be provided so as to be adjacent to a position on the rear end side L2 in the longitudinal direction L of the atmosphere electrode 312. As a result, the toxic substances in an atmospheric air (reference gas) A can be captured by the trap layer 5 while the state in which the trap layer 5 is heated to a temperature of 500° C. or higher is maintained. In addition, in this case, an amount of gaps in the porous body that configures the trap layer 5 can be increased, and the atmospheric air A can be made to more easily pass through the trap layer 5.

### (Average Film Thickness d of Trap Layer 5)

As shown in FIG. 5, an average film thickness (average thickness) d of the trap layer 5 on the surface of the atmosphere electrode 312 can be equal to or greater than 10 μm and equal to or less than 500 μm. The film thicknesses at 10 to 100 sites on the trap layer 5 on the surface of the atmosphere electrode 312 can be measured, and an average value of these film thicknesses can be set as the average film thickness d. The trap layer 5 on the surface of the atmosphere electrode 312 is preferably formed to have an overall film thickness that is as uniform as possible.

When the average film thickness d of the trap layer 5 on the surface of the atmosphere electrode 312 is less than 10 μm, the trap layer 5 may be thin and capability for adsorbing (attaching) toxic substances may be insufficient. Meanwhile, when the average film thickness d of the trap layer 5 on the surface of the atmosphere electrode 312 exceeds 500 μm, the trap layer 5 is thick. Permeating gas resistance of the trap layer 5 may increase, that is, gas permeability may decrease, and a sufficient amount of atmospheric air A may not be supplied to the atmosphere electrode 312.

### (Average Pore Diameter φe of Macropores K1)

As shown in FIG. 6, an average pore diameter φe of the macropores L1 can be made greater than a particle size of the particles of the α-alumina that serves as the metal oxide. In addition, as a result of a size, a number formed per unit volume, and the like of the macropores K1 being changed, ease of capture of toxic substances and ease of passage of atmospheric air A (air) of the trap layer 5 can be changed.

The average pore diameter φe of the macropores K1 in the trap layer 5 can be set to be equal to or greater than 0.4μ. As a result of this configuration, clogging of the trap layer 5 as a result of capture of toxic substances does not easily occur. In addition, for example, the average pore diameter φe of the macropores K1 may be set to be equal to or less than 10 μm that is less than the average film thickness d of the trap layer 5.

Furthermore, when the macropores K1 are formed by the burnout agent S, the size of the macropores K1 is proportional to a size of the burnout agent S that is used. Therefore, as a result of the size of the burnout agent S being changed, the average pore diameter φe of the macropores K1 can be changed. Moreover, as a result of the sizes of a plurality of burnout agents S that are used being made uniform, the sizes of the macropores K1 that are formed can also be made uniform. For example, the macropores K1 may be formed within a range of 1 to 5 μm in size through use of the burnout agent S that is within a range of 1 to 5 μm in size.

The average pore diameter φe of the macropores K1 can be an average value of the pore diameters of 10 to 100 macropores K1 that appear on a cross-section on which the trap layer 5 is cut. The cross-section on which the trap layer 5 is cut can be observed under a scanning electron microscope (SEM) or the like, maximum lengths of a plurality of macropores L1 included in a unit cross-sectional area can be measured, and an average of the maximum lengths can be determined as the average pore diameter φe of the macropores K1.

In addition, regarding the average pore diameter φe of the macropores K1, when the cross-section on which the trap layer 5 is cut is observed, a plurality of measurement lines X are set on the cross-section. Then, a length m of each macropore K1 and a number n1 of macropores K1 on each measurement line X are measured, and an average value of the length m of the macropores K1 on the overall measurement line X is determined by Σm/n1. Furthermore, when a number of measurement lines X is n, the average pore diameter φe of the macropores K1 can be expressed by an expression φe=Σn(Σm/n1)/n.

The measurement lines X on the cross-section of the trap layer 5 can be set at even intervals on the cross-section of the trap layer 5. The length m of the macropore K1 can be observed using the SEM.

### (Diffusion Tortuosity Factor f of Trap Layer 5)

As shown in FIG. 5, in the trap layer 5, it can be said that the toxic substances are more easily captured as a path of gaps formed by the macropores K1 and the inter-particle gaps K2 through which the atmospheric air A passes becomes longer. Meanwhile, when the path of gaps through which the atmospheric air A passes becomes too long, the atmospheric air A does not easily reach the atmosphere electrode 312 and the detection performance of the gas sensor 1 may be affected. In addition, when the path of gaps through which the atmospheric air A passes becomes too long, the toxic substances that are captured in the gaps may cause clogging of the trap layer 5. According to the present embodiment, a diffusion tortuosity factor f of the trap layer 5 is used as a measure that is related to the length of the path of gaps.

The diffusion tortuosity factor f can be expressed as an average value of values that are obtained by a total sum Σm of the lengths m of the macropores K being divided by the length (thickness) d of the trap layer 5 for each measurement line X, a plurality of measurement lines X being set on a cross-section when a cross-section on which the trap layer 5 is cut is observed. When the number of measurement lines X is n, the diffusion tortuosity factor f can be expressed by an expression f=Σn(Σm/d)/n. The length d of the trap layer 5 can be measured for each measurement line X.

### (Manufacturing Method for Sensor Element 2)

When the sensor element 2 is manufactured, a paste material that configures the exhaust electrode 311 and the atmosphere electrode 312 is printed on (applied to) the sheet that configures the solid electrolyte body 31, and a paste material that configures the heat generating body 34 is printed on (applied to) the sheet that configures the second insulating body 33B. In addition, a paste material that configures the trap layer 5 is printed on (applied to) a surface of the paste material that configures the atmosphere electrode 312. Then, the sheet that configures the solid electrolyte body 31, the sheet that configures the first insulating body 33A, the sheet that configures the second insulating body 33B, and the like are laminated together and adhered by an adhesive. Subsequently, an intermediate body of the sensor element 2 that is formed by the sheets and the paste materials is fired at a predetermined firing temperature, and the sensor element 2 is formed.

When the intermediate body of the sensor element 2 is fired, should the burnout material S be contained in the paste material that configures the trap layer 5, the burnout material S is burned out when the intermediate body is heated. The micropores K1 are then formed in the locations in which the burnout material S is placed in the intermediate body, and the sensor element 2 is formed.

### (Other Configurations of the Sensor Element 2)

The sensor element 2 can also be that in which a reference electrode is used instead of the atmospheric air duct 36 and the atmosphere electrode 312. In this case, the reference electrode that is used so as to be paired with the exhaust electrode 311 can be arranged on the second surface 302 of the solid electrolyte body 31 of the sensor element 2 in a position that overlaps the exhaust electrode 311 in the lamination direction D. The reference electrode is embedded between the second surface 302 of the solid electrolyte body 31 and the surface of the second insulating body 33B. In addition, the atmospheric-air introduction path through which the atmospheric air A is introduced to the reference electrode can be the electrode lead portion 313 for the reference electrode that is arranged in a boundary position between the second surface 302 of the solid electrolyte body 31 and the surface of the second insulating body 33B (see FIG. 2).

In this case, the oxygen in the atmospheric air A that is present in the rear end position of the sensor element 2 moves over the electrode lead portion 313 of the reference electrode from the rear end side L2 to the tip end side L1 in the longitudinal direction L and is supplied to the reference electrode. In this case, the trap layer 5 can be provided in the vicinity of the electrode lead portion 313 in the rear end position in the longitudinal direction L of the sensor element 2.

### (Working Effects)

In the sensor element 2 of the gas sensor 1 according to the present embodiment, the trap layer 5 is provided so as to cover the atmosphere electrode 312 that is provided on the second surface 302 of the solid electrolyte body 31 inside the atmospheric air duct 312. As a result, even when a large amount of oxygen in the atmospheric air A is required in the atmospheric air duct 36 and the atmosphere electrode 312 of the sensor 2, the toxic substances in the atmospheric air A can be captured by the trap layer 5 and the large amount of oxygen can be supplied to the atmospheric air duct 36 and the atmosphere electrode 312.

More specifically, the gas sensor 1 according to the present embodiment is used as the air-fuel ratio sensor. When the air-fuel ratio of the internal combustion engine is A/F=10 or less and on the fuel-rich side, a large amount of oxygen is required in the atmosphere electrode 312 to react with the unburned gas that comes into contact with the exhaust electrode 311. At this time, when the atmosphere electrode 312 is in a degraded state as a result of deposit of toxic substances, the atmosphere electrode 312 may not sufficiently function and a current output that indicates the air-fuel ratio on the fuel-rich side may not be sufficiently obtained. Detection accuracy regarding the air-fuel ratio on the fuel-rich side may become poor.

In the gas sensor 1 according to the present embodiment, the trap layer 5 is provided so as to cover the atmosphere electrode 312 without filling the atmospheric air duct 36. As a result, the atmosphere electrode 312 can become less easily degraded by toxic substances while the amount of supply of atmospheric air A to the atmosphere electrode 312 is ensured. As a result, detection accuracy regarding the air-fuel ratio on the fuel-rich side can be improved.

Consequently, in the gas sensor 1 according to the present embodiment, the toxic substances can be captured and degradation of the atmosphere electrode 312 can be suppressed. In addition, the required oxygen can be supplied to the atmospheric air duct 36 and the atmosphere electrode 312. Furthermore, accuracy of gas detection by the gas sensor 1 can be improved.

### <Confirmation Test>

In a present confirmation test, a case in which the air-fuel ratio is A/F=10 that is fuel-rich was assumed. Whether output accuracy of the gas sensor can be maintained when the temperature [° C.], the average film thickness d [μm], the average pore diameter φe [μm], or the diffusion tortuosity factor f[−] of the trap layer 5 of the sensor element 2 changes was confirmed. Test samples of the gas sensor are test products 1 to 8 and comparison products 1 to 3 of which the temperature, the average film thickness d, the average pore diameter φe, or the diffusion tortuosity factor f differs.

The average film thickness d, the average pore diameter φe, and the diffusion tortuosity factor f of the trap layer 5 are those described according to the present embodiment and measured by methods described according to the present embodiment. The trap layers 5 in the test samples are provided so as to cover the overall atmosphere electrode 312 on the second surface 302 of the solid electrolyte body 31 or are provided in the atmospheric air duct 36 in a position further toward the rear end side L2 in the longitudinal direction L than the arrangement location of the atmosphere electrode 312. The former is referred to as an “electrode position” and the latter is referred to as a “duct position”. In addition, the trap layers 5 may be provided in both the “electrode position” and the “duct position”.

In the test samples of the gas sensor, when the air-fuel ratio of AF=10 is outputted, an output current of −0.7 mA is outputted between the exhaust electrode 311 and the atmosphere electrode 312 (a state in which a current of 0.7 mA flows from the exhaust electrode 311 to the atmosphere electrode 312). In addition, in the present confirmation test, as a result of a voltage of 0.3 V (a voltage at which the atmosphere electrode 312 becomes a minus side (low voltage side)) being applied between the exhaust electrode 311 and the atmosphere electrode 312, a state in which the output current that indicates the air-fuel ratio of AF=10 is outputted is created.

Furthermore, siloxane gas at a concentration of 10 ppm (volume ratio) was introduced into the atmospheric air A that is taken into the atmospheric air duct 36 in the test samples of the gas sensor. The siloxane gas refers to a compound that has a siloxane bond (Si—O—Si bond). In addition, after a state in which the voltage of 0.3 V is applied and a state in which the test samples are arranged in the atmospheric air A that contains 10 ppm of siloxane gas had continued for eight hours, whether the output current between the exhaust electrode 311 and the atmosphere electrode 312 in the test samples became lower in absolute value than −0.7 mA (whether the output current moved further toward a positive side than −0.7 mA) was confirmed.

Configurations of the test products 1 to 8 and the comparison products 1 to 3, and evaluations of the output currents that are results of the confirmation test are shown in Table 1.

TABLE 1

| | Formation position of | Temperature | Average film | Average pore | Diffusion tortuosity | Evaluation of |
|---|---|---|---|---|---|---|
| | trap layer | [° c.] | thickness d [μm] | diameter φe [μm] | factor f [−] | output current |
| Test product 1 | Duct position | 500 | 100 | 2 | 0.5 | Good |
| Test product 2 | Duct position | 500 | 500 | 2 | 0.5 | Good |
| Test product 3 | Electrode position | 700 | 10 | 2 | 0.5 | Good |
| Test product 4 | Electrode position | 700 | 100 | 2 | 0.5 | Good |
| Test product 5 | Electrode position | 700 | 500 | 2 | 0.5 | Good |
| Test product 6 | Electrode position | 700 | 500 | 0.4 | 0.2 | Good |
| Test product 7 | Electrode position | 700 | 100 | 5 | 0.5 | Good |
| Test product 8 | Electrode position + | 700 | 10 | 2 | 0.5 | Good |
| | duct position | | | | | |
| Comparison | Duct position | 300 | 100 | 2 | 0.5 | Poor |
| product 1 | | | | | | |
| Comparison | Duct position | 500 | 1000 | 2 | 0.1 or less | — |
| product 2 | | | | | | |
| Comparison | Electrode position | 700 | 100 | 0.3 | 0.1 or less | Poor |
| product 3 | | | | | | |

In the evaluation of the output currents in Table 1, a case in which the output current falls below −0.7 mA is indicated by “poor”. A case in which the output current is maintained at −0.7 mA is indicated by “good”. In addition, a case in which the output current cannot be measured is indicated by “-”.

As shown in Table 1, in the comparison product 1, because the temperature at the position in which the trap layer 5 is arranged is 300° C. and is low, the output current also became lower in absolute value than −0.7 mA. In addition, in the comparison product 2, because the average film thickness d of the trap layer 5 is 1000 μm and is large, and the diffusion tortuosity factor f of the trap layer 5 is equal to or less than 0.1 and is small, the output current could not be obtained. Furthermore, in the comparison product 3, because the average pore diameter φe of the trap layer 5 is 0.3 μm and is small, and the diffusion tortuosity factor f of the trap layer 5 is equal to or less than 0.1 and is small, clogging occurred in the trap layer 5, and the output current became lower in absolute value than −0.7 mA. Therefore, regarding the comparison products 1 to 3, the evaluation of the output current is “poor” or “-”. It has been found that the output accuracy of the gas sensor cannot be maintained.

Meanwhile, in the test products 1 to 8, the temperature, the average film thickness d, the average pore diameter φe, and the diffusion tortuosity factor f are all appropriate, and the evaluation of the output current is “good”. In addition, it has been found that the trap layer 5 appropriately adsorbs the toxic substances and the output accuracy of the gas sensor can be kept high.

The present disclosure is not only limited to the embodiments. Further differing embodiments are also possible without departing from the spirit of the invention. In addition, the present disclosure includes various modification examples, modification examples within the range of equivalency, and the like. Furthermore, combinations of various constituent elements, modes, and the like that are assumed from the present disclosure area also included in the technical concept of the present disclosure.

What is claimed is:

1. A gas sensor comprising:
a sensor element that has an atmospheric-air introduction path into which atmospheric air is introduced, wherein:
the sensor element includes
a solid electrolyte body that has ion conductivity,
an insulating body that is laminated onto the solid electrolyte body,
an exhaust electrode that is provided in the solid electrolyte body and exposed to an exhaust gas, and
an atmosphere electrode that is provided in a position that opposes the exhaust electrode in the solid electrolyte body, is used so as to be paired with the exhaust electrode, and is exposed to atmospheric air;
the atmospheric-air introduction path is formed so as to house the atmosphere electrode in a section of the insulating body that opposes the solid electrolyte body;
the atmospheric-air introduction path is provided with a trap layer for capturing toxic substances in the sensor element, the trap layer being formed to include a porous body of a metal oxide that has insulating properties;
in the trap layer, macropores and inter-particle gaps are formed, the macropores being formed because of unevenness in a distribution of particles of the metal oxide, the inter-particle gaps being smaller than the macropores, and being formed between the particles of the metal oxide; and
an average pore diameter of the macropores is equal to or greater than 0.4μ, and is less than the average film thickness of the trap layer.

2. The gas sensor according to claim 1, wherein:
the trap layer has a diffusion tortuosity factor that is expressed as an average value of values that are obtained by a total sum of lengths of the macropores being divided by a length of the trap layer for each of a plurality of measurement lines that are set on a cross-section when a cross-section on which the trap layer is cut is observed, the diffusion tortuosity factor of the trap layer being equal to or greater than 0.2, and being equal to or less than 0.5.

3. The gas sensor according to claim 2, wherein:
the sensor element is formed in an elongated shape;
the exhaust electrode and the atmosphere electrode are arranged in sections on a tip end side that is exposed to the exhaust gas in a longitudinal direction of the sensor element;
the atmospheric-air introduction path is formed from a section of the insulating body in the longitudinal direction in which the atmosphere electrode is housed to a rear end position in the longitudinal direction of the sensor element that is exposed to the atmospheric air.

4. The gas sensor according to claim 3, wherein:
the trap layer is formed to include a porous body of a metal oxide, and covers a portion or an entirety of the atmosphere electrode.

5. The gas sensor according to claim 3, wherein:
the trap layer is formed to include a porous body of a metal oxide, and is formed on a surface of at least either of the solid electrolyte body and the insulating body that form the atmospheric-air introduction path, inside the atmospheric-air introduction path.

6. The gas sensor according to claim 3, wherein:
the trap layer is formed to include a porous body of a metal oxide, and covers a portion or an entirety of the atmosphere electrode;
a length in the longitudinal direction of a rear-end-side portion of the trap layer that is formed so as to protrude from a rear end in the longitudinal direction of the atmosphere electrode toward a rear end side in the longitudinal direction is longer than a length in the longitudinal direction of a tip-end side-portion of the trap layer that is formed so as to protrude from a tip end in the longitudinal direction of the atmosphere electrode toward the tip end side in the longitudinal direction.

7. The gas sensor according to claim 6, wherein:
a heat generating body for heating the solid electrolyte body is embedded in the insulating body;
a heat generating portion in the heat generating body is arranged so as to oppose a position in which the exhaust electrode and the atmosphere electrode are provided;
in a longitudinal direction of the solid electrolyte body, a temperature distribution that is based on heating by the heat generating portion and in which a temperature becomes higher in sections closer to the heat generating portion is formed; and
the trap layer is provided in a position in which the temperature in the temperature distribution is 500° C. or higher.

8. The gas sensor according to claim 7, wherein:
the trap layer is formed to include a porous body of α-alumina.

9. The gas sensor according to claim 1, wherein:
the sensor element is formed in an elongated shape;
the exhaust electrode and the atmosphere electrode are arranged in sections on a tip end side that is exposed to the exhaust gas in a longitudinal direction of the sensor element;
the atmospheric-air introduction path is formed from a section of the insulating body in the longitudinal direction in which the atmosphere electrode is housed to a rear end position in the longitudinal direction of the sensor element that is exposed to the atmospheric air.

10. The gas sensor according to claim 1, wherein:
the trap layer is formed to include a porous body of a metal oxide, and covers a portion or an entirety of the atmosphere electrode.

11. The gas sensor according to claim 1, wherein:
the trap layer is formed to include a porous body of a metal oxide, and is formed on a surface of at least either of the solid electrolyte body and the insulating body that form the atmospheric-air introduction path, inside the atmospheric-air introduction path.

12. The gas sensor according to claim 1, wherein:
the trap layer is formed to include a porous body of a metal oxide, and covers a portion or an entirety of the atmosphere electrode;
a length in the longitudinal direction of a rear-end-side portion of the trap layer that is formed so as to protrude from a rear end in the longitudinal direction of the atmosphere electrode toward a rear end side in the longitudinal direction is longer than a length in the longitudinal direction of a tip-end side-portion of the trap layer that is formed so as to protrude from a tip end in the longitudinal direction of the atmosphere electrode toward the tip end side in the longitudinal direction.

13. The gas sensor according to claim 1, wherein:
a heat generating body for heating the solid electrolyte body is embedded in the insulating body;
a heat generating portion in the heat generating body is arranged so as to oppose a position in which the exhaust electrode and the atmosphere electrode are provided;
in a longitudinal direction of the solid electrolyte body, a temperature distribution that is based on heating by the heat generating portion and in which a temperature becomes higher in sections closer to the heat generating portion is formed; and
the trap layer is provided in a position in which the temperature in the temperature distribution is 500° C. or higher.

14. The gas sensor according to claim 1, wherein:
the trap layer is formed to include a porous body of α-alumina.
